(19) United States
(12) Patent Application Publication
(10) Pub. No.: US 2010/0209806 A1
(43) Pub. Date: Aug. 19, 2010

(54) MEMBRANE ELECTRODE ASSEMBLY

(75) Inventors: Carsten Cremers, Karlsruhe (DE); Michael Krausa, Arlesheim (CH)

Correspondence Address: WARN, HOFFMANN, MILLER & LALONE, .P.C, PO BOX 70098, ROCHESTER HILLS, MI, 48307, US

(73) Assignee: Fraunhofer-Gesellschaft zur Forderung der angewandten Forschung e.V., Munchen (DE)

(21) Appl. No.: 12/452,521

(22) PCT Filed: Jul. 3, 2008
(86) PCT No.: PCT/EP2008/058551

§ 371 Date: Apr. 20, 2010

(30) Foreign Application Priority Data
Jul. 6, 2007 (DE) 10 2007 031 526.2

(51) Int. Cl. H01M 8/10; H01M 4/02; H01M 4/92; H01M 4/90; H01M 4/88; H01M 8/00

(52) U.S. Cl. 429/483; 429/523; 429/524; 429/526; 502/101; 429/535

(57) ABSTRACT

Membrane electrode assembly (MEA) with an anode, which contains at least two catalytically active metals which are not alloyed with one another, wherein at least one first catalytically active metal (A) oxidizes ethanol and at least one second catalytically active metal (B) oxidizes acetaldehyde.

The present invention relates to an electrode, which is suitable for the use in a direct ethanol fuel cell (DEFC), as well as to a membrane electrode assembly (MEA) and to a fuel cell wherein the electrode according to the invention is used.

The fields of application of fuel cells are versatile. One field of application relates to portable electrical appliances such as computers. In such apparatuses the use of low-temperature fuel cells is desired. Furthermore, it is generally preferred to operate fuel cells by means of alcohols. Highly promising experiments could be performed with direct methanol fuel cells (DMFC) until today. However, the operation of fuel cells with ethanol or higher alcohols did not work. A problem in this regard consists in the fact that at relative low temperatures ethanol or other higher alcohols can hardly be oxidized to obtain CO₂. In particular toxic acetaldehyde evolves during the oxidation of ethanol, which must be oxidized in order to allow a commercial use of direct ethanol fuel cells (DEFC).

When developing suitable catalyst systems for the oxidation of alcohols in particular platinum tin alloys have been used. Other highly promising alloys consist of platinum and an element from the group of the lanthanides, in particular cerium, lanthanum or praseodymium. Moreover alloys based on ternary systems have been used as well. However, no catalyst system could be developed up to date which satisfactory converts ethanol or higher alcohols.

Therefore it is an object of the present invention to provide an electrode for the use in a fuel cell which is to be operated by means of ethanol or higher alcohols, in particular a direct ethanol fuel cell (DEFC). Furthermore it is an object of the present invention to develop a membrane electrode assembly (MEA) for the above-mentioned fuel cell.

The finding of the present invention is based on the fact that intermediate oxidation products of ethanol and/or higher alcohols, like aldehydes, e.g. acetaldehyde, must be oxidized further within a second step. Another finding of the present invention is based on the fact that the oxidation of ethanol and/or higher alcohols can be attained by a mixture of two different catalytically active metals, which are not alloyed with one another.

Therefore the present invention relates to an electrode comprising at least two catalytically active components (A) and (B) which are not alloyed with one another and which are present on and/or within the said electrode, wherein

(a) at least one first catalytically active metal and/or alloy as component (A) oxidizes ethanol and/or at least one C3 to C10 containing alcohol and
(b) at least one second catalytically active metal and/or alloy as component (B) oxidizes acetaldehyde (CH₃CHO) and/or at least one C3 to C10 containing aldehyde and/or acetic acid and/or at least one C2 to C9 containing carboxylic acid.

Preferably the second catalytically active metal and/or alloy oxidizes acetaldehyde (CH₃CHO) and/or at least one C3 to C10 containing aldehyde.

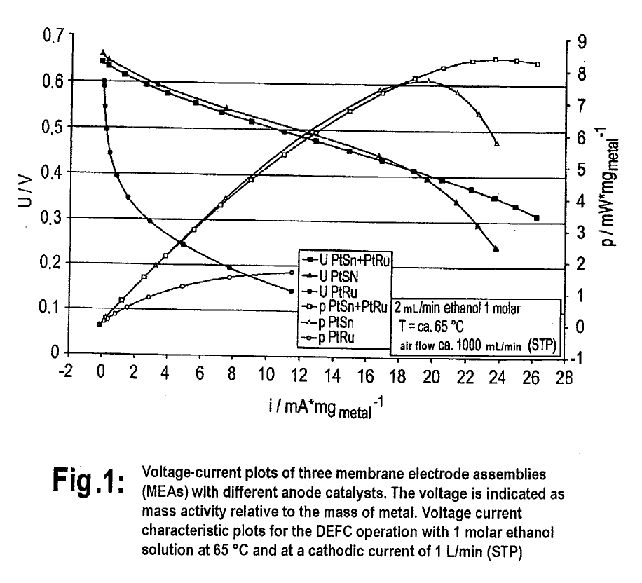

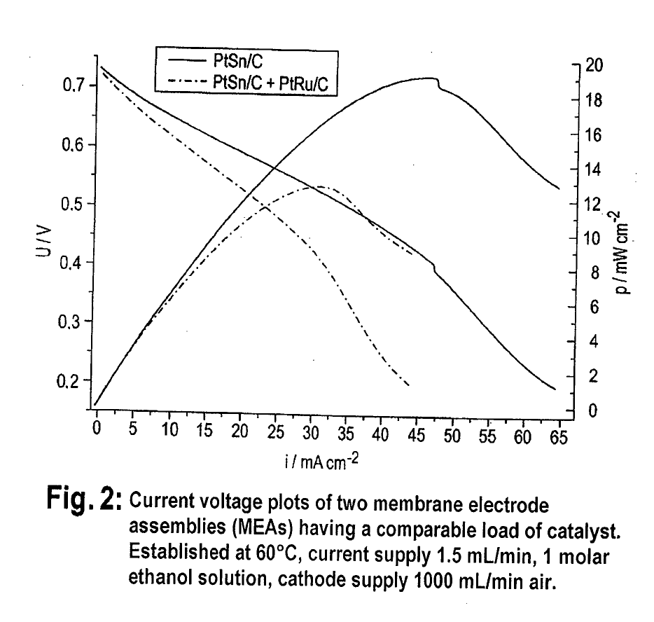

Surprisingly it has been turned out that such an electrode allows a sufficient oxidation of ethanol or higher alcohols and therefore allows the provision of membrane electrode assemblies (MEA) having significant higher power densities than known membrane electrode assemblies (MEA) which are operated with ethanol (see FIGS. 1 and 2).

An electrode according to the present invention is an electrically conductive part within an electrical or electronic component or device, in particular within a membrane electrode assembly (MEA), at which an electrochemical reaction takes place and which leads off the charge carriers freed during this electrochemical reaction to the contacting electron- and ion-conductors, in particular, the electrolyte membrane of a MEA.

A compulsory prerequisite of the electrode is that it comprises at least two catalytically active components (A) and (B) which have not been alloyed with each other.

The term “alloy” is to be understood in the general conventional meaning. Therefore an alloy is a metallic mixture of at least two components, from which at least one is a metal. Thus the present invention requires that the electrode, preferably the anode, comprises two components (A) and (B), which are not present in a metallic mixture—in the sense of an alloy. On the other side the individual components (A) and (B) per se may represent metals or alloys.

Furthermore components (A) and (B) must be catalytically active, especially component (A) must oxidize ethanol and/or higher alcohols at low temperatures, i.e. below 90° C., preferably below 80° C. and in particular below 70° C. Component (B) must allow the oxidation of acetaldehyde and/or higher aldehydes and/or acetic acid and/or higher carboxylic acids in the same temperature range. Preferably component (B) allows the oxidation of acetaldehyde and/or higher aldehydes, in particular of acetaldehyde. However it is not necessary, as surprisingly has been shown, that the component (B) per se is active for the oxidation of the ethanol and/or the higher alcohols.

In the following the two compulsory components (A) and (B) are described in more detail.

Component (A) is a first catalytically active metal and/or alloy which oxidizes the ethanol and/or at least one C3 to C10 containing alcohol. The C3 to C10 containing alcohol preferably relates to n-butanol, isopropanol, pentanol, such as n-pentanol, or hexanol, such as n-hexanol. The component (A) can preferably oxidize mixtures from ethanol and C3 to C10 containing alcohols. The mixtures may be mixtures of two, three or four, preferably two, alcohols as defined in the present invention, in particular a mixture of ethanol and butanol. In the case that no mixture is present component (A) can preferably oxidize ethanol. In this case it is preferred that the alcohols are oxidized to obtain at least aldehydes. In particular it is preferred that component (A) oxidizes ethanol to obtain acetaldehyde. It is also conceivable that component (A) oxidizes the alcohol to obtain acids, such as acetic acid. Therefore component (A) can oxidize in particular ethanol to obtain acetaldehyde and acetic acid.

Therefore, component (A) is preferably a first catalytically active metal and/or alloy which comprises an element of the group 10 or 9 of the periodic table, preferably platinum (Pt) or rhodium (Rh), in particular platinum (Pt). It is more preferred that component (A) is an alloy. If component (A) is an alloy, it is preferred that the alloy comprises another element of the group 14 of the periodic table, preferably tin (Sn). Thus component (A) in this particular embodiment is an alloy with two components. A special member of component (A) is PtSn.

In order to obtain especially good results, it is preferred that component (A) is supported (e.g. on carbon). Therefore a particularly suitable component (A) is the catalyst PtSn/C.

Another prerequisite of the present invention is that the electrode comprises a further catalytically active component (B) which is not alloyed with component (A). This component (B) must be able to further decompose and/or oxidize the oxidation products, in particular, oxidation products produced by component (A). Therefore component (A) and (B) are different catalysts. In particular the two components (A) and (B) differ in the catalytically active metal and/or in the catalytically active alloy.

Therefore component (B) is a second catalytically active metal and/or alloy, which oxidizes acetaldehyde (CH₃CHO) and/or at least one C3 to C10 containing aldehyde. The C3 to C10 containing aldehyde is preferably n-butanal, pentanal, such as n-pentanal, or hexanal, such as n-hexanal. The component (B) can preferably oxidize mixtures from acetaldehyde (CH₃CHO) and C3 to C10 containing aldehydes. The mixtures may be mixtures of two, three or four, preferably two, aldehydes as defined in the present invention, in particular a mixture of acetaldehyde (CH₃CHO) and butanal. In the case that no mixture is present component (B) can preferably oxidize acetaldehyde (CH₃CHO). In particular it is preferred that the aldehydes are converted to CO₂, for example (B) oxidizes acetaldehyde (CH₃CHO) to obtain CO₂.

In order to achieve good conversion rates it is desired that a high proportion of acetaldehyde (CH₃CHO) and/or C3 to C10 containing aldehydes will be oxidized. Therefore it is preferred that component (B) oxidizes at least 50 wt.-%, preferably at least 70 wt.-%, in particular at least 90 wt.-%, such as at least 99 wt.-%, aldehyde.

Therefore component (B) is preferably a second catalytically active metal and/or alloy which comprises an element of the group 10 or 9 of the periodic table, preferably platinum (Pt). It is especially preferred that component (B) is an alloy. If component (B) is an alloy, it is preferred that the alloy comprises another element of the group 8 of the periodic table, preferably ruthenium (Ru) or rhodium (Rh), in particular ruthenium (Ru). Therefore in a particular embodiment component (B) is an alloy with two components. A special member of component (B) is PtRu.

In order to achieve especially good results, is it preferred that component (B) is supported (e.g. on carbon). Therefore a particularly suitable component (B) is the catalyst PtRu/C.

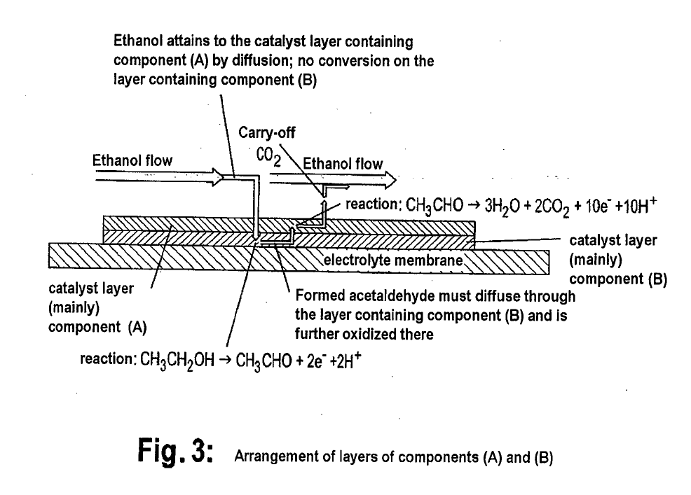

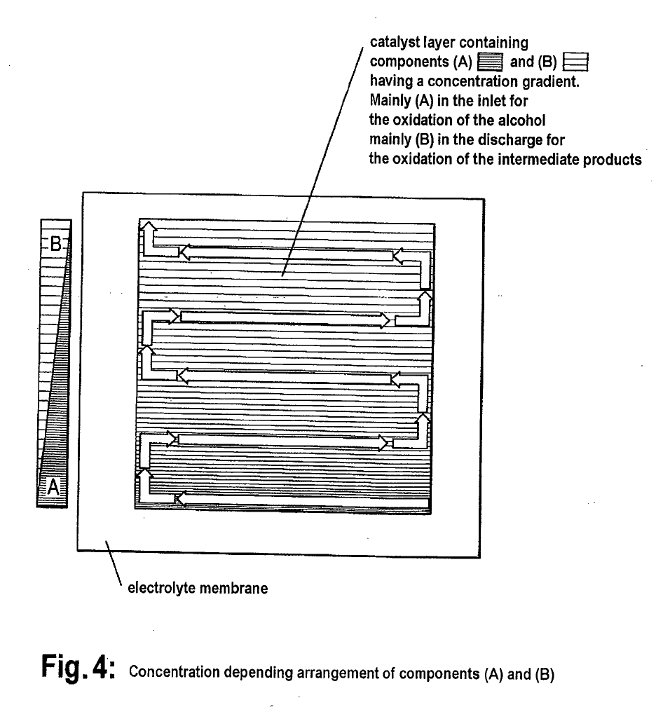

As already mentioned above a compulsory prerequisite in the present invention is that components (A) and (B) together do not result in an alloy, i.e. they do not form metallic mixtures but separately defined (chemical) units. The components can be homogeneous distributed on and/or in the electrode. In another embodiment the components, in particular the components (A) and (B), are arranged in a manner that reactants, i.e. the alcohols, in particular ethanol, may be reacted stepwise. In particular the electrode according to the invention should be suitable for membrane electrode assemblies (MEA) in fuel cells. Therefore, a stepwise conversion of the alcohols, in particular ethanol, is given if the components (A) and (B) have been applied on to the electrode layer by layer, or if the components (A) and (B) are present on the electrode membrane in varying concentrations. Thus, a preferred embodiment is a three-layer construction, in which component (A) represents the middle layer and the electrode membrane covers a side of the middle layer, whereas the component (B) covers at least partial, preferably the whole other side of the middle layer (see FIG. 3). In an alternative embodiment components (A) and (B) are applied in varying concentrations on to the electrolyte membrane (see FIG. 4). The concentration of component (A) at the inlet (i.e. high alcohol concentration) is relatively high and the concentration of component (B) is relatively small. Towards the outlet or discharge the ratio inverts accurately, i.e. the concentration of component (B) is relatively high and the concentration of component (A) is relatively small.

The electrode can comprise still further catalytically active components, which optionally provide different oxidation products from the starting materials and/or continue to convert other oxidation products. Thus, it is in particular conceivable that the electrode comprises still catalytically active components which allow a further conversion from acetic acid to CO₂.

In order to obtain especially good results the ratio of catalytically active metals of the components (A) and (B) should be approximately the same. Therefore, it is preferred that the weight ratio of the metal portion between the first component (A) and the second component (B) is 3:1 to 1:3, preferably 2:1 to 1:2, in particular 1.5:1 to 1:1.5, such as 1:1.

Moreover, it is preferred that the electrode—apart from components (A) and (B)—comprises an ionomer. Ionomers are thermoplastic resins. Ionomers are obtained by copolymerization of a non-polar monomer with a polar monomer. The polar bonds suppress the crystallization and lead to an “ionic cross-linking”.

In contrast to conventional thermoplastics ionomers have the advantage that both secondary valence forces and ionic bonds become effective within them. These ionic bonds are particularly strong and provide the substance with its characteristic properties. Moreover, in contrast to most other plastics ionoplastics may serve as electrolytes.

A member of this class is Nafion, a sulfonated tetrafluoroethylene polymer (PTFE), with a density of approximately 2100 kg/m³ and an electrical conductivity of approximately 0.5-10⁻³-2.31 10⁻³ (m·Ohm)⁻¹. Another member of this class is a sulfonated polyether ether ketone (sPEEK).

Preferably the electrode comprises at least 20 wt.-%, more preferred at least 30 wt.-%, of an ionomer. In a particular embodiment the portion of ionomer in the electrode is within the range of 30 to 50 wt.-%.

It is also conceivable that for the preparation of the electrode according to the invention an agent for forming pores, such as di-ammonium carbonate (NH₄)₂CO₃ or ammonium bicarbonate NH₄HCO₃, is used.

The electrode according to the invention is used as an anode, preferably as an anode electrode of a membrane electrode assembly (MEA) in particular in fuel cells.

Therefore the present invention relates also to a membrane electrode assembly or a fuel cell comprising an electrode according to the present invention.

Preferably the anode of the membrane electrode assembly (MEA) is the electrode as described in the present invention. Moreover, it is favorable if the membrane electrode assembly (MEA) as membrane comprises a proton exchange membrane, in particular an ionomer as described above. Preferably the electrode according to the invention has been hot-pressed on to the proton exchange membrane. Alternatively the electrode structure can also be applied by hot spraying, coating with doctor blades or screen printing. As the cathode the conventional cathodes from the state of the art can be used, e.g. platinum or platinum alloys e.g. with cobalt.

Finally the present invention relates also to a fuel cell comprising an electrode according to the present invention, which serves as an anode within the fuel cell. Preferably such a fuel cell has one membrane electrode assembly (MEA) as described above. In a particular embodiment the fuel cell is a direct ethanol fuel cell, i.e. the fuel cell comprises an anode compartment which is filled with ethanol.

The present invention comprises also the preparation of the electrode according to the invention. That is, component (A) and component (B) are mixed to obtain some of the possible embodiments of the invention. During mixing it must be paid attention to the fact that too high pressures, which, for instance, may be developed when mixing by means of mortars, a ball mill or another mechanical grinding mechanism, should be avoided, in order to avoid any formation of undesirable alloys between component (A) and component (B). Subsequently water and an ionomer dispersion are preferably added to the so prepared mixture and the mixture is blended. The so obtained ink is applied to a substrate, e.g. by spraying. If a membrane electrode assembly (MEA) is to be prepared the substrate is preferably a proton exchange membrane as described above. Alternatively the substrate may also be a gas diffusion medium e.g. carbon papers or carbon felts as sold by Toray or SGL carbon (trade name Sigracet). This is then applied onto the proton exchange membrane in another step by means of hot pressing.

For the preparation of a membrane electrode assembly (MEA) with a gradient configuration as described above:

(a) the first catalytically active metal and/or alloy (A) and the second catalytically active metal and/or alloy (B) are mixed in several mixtures having different ratios; then
(b) water and an ionomer dispersion are added to the individual mixtures and are blended;
(c) the individual mixtures are coated with a doctor knife onto a substrate in the form of stripes, so that the sequence of the stripes forms a linear gradient in the ratio of component A to component B.

In more detail the preparation of a MEA having a gradient configuration comprises the following steps:

Step a) Several inks, preferably five inks, have been prepared which contain components A and B in different ratios, in particular in the ratios 3:1, 2:1, 1:1, 1:2 and 1:3. Each of components A and B is weighed in the corresponding weight ratio and in each case the fivefold amount of water and of an ionomer dispersion, such as a Nafion solution has been added. The amount of ionomer dispersion, such as a Nafion solution, has been selected in a manner so that later the proportion of ionomer, such as e.g. the proportion of Nafion, on the solid amounts preferably to 40 wt.-%. Approximately 10 minutes before processing preferably di-ammonium carbonate has been added to the inks, so that its proportion on the solid amounts to preferably to 10 wt.-%.
Step b) A stripe of each ink is applied at the edge of a suitable substrate e.g. a carbon felt of the type Sigracet 35AC preferably over a fifth of the length of the edge in the order of the ratio A:B=3:1, 2:1, 1:1, 1:2, 1:3. Subsequently the ink is distributed by means of a doctor blade away from the applying edge uniformly over the substrate. The so obtained first electrode layer is dried in an oven at preferably 130° C. in air, so that a porous, highly adhesive structure has been formed.
Step c) Step b is repeated as often as the desired metal loading has been achieved. The stripes having the same catalyst composition are always arranged one above the other.
Step d) The electrode is connected by hot-pressing with a membrane, such as a Nafion membrane, and a cathode electrode to obtain a MEA.
Step e) The finished MEA is preferably incorporated into a DEFC or a DEFC stack, whereby the stripe with the highest concentration of component A is oriented to the fuel inlet and the stripe with the highest concentration of component B is oriented to the fuel discharge opening (see FIG. 4).

In the following the invention is explained in more detail by means of examples.

### EXAMPLES

### 1) Preparation of a Membrane Electrode Assembly (MEA) by the Hot Spraying Process

For the anode PtSn/C (component (A)) (e.g. E-Tek C 14-40/Sn HP % PtSn Alloy (3:1 a/o) on Vulcan XC72) and PtRu/C (component (B)) (e.g. Johnson & Matthey HiSPEC10000 40% platinum, 20% ruthenium on carbon black) catalysts have been used. The two catalysts are mixed in the weight ratio 2:1 based to the metal proportion and the 10 times weight of water and the ionomer dispersion Nafion solution have been added and are intimate blended, whereby the amount of ionomer dispersion has been selected in a manner so that the electrode contains 40 wt.-% of ionomer relative to the solid. The so obtained ink is sprayed on a gas diffusion medium, which is heated at 120-140° C., so that the water has rapidly been evaporated and the ionomer binds strong to the catalyst particles and the substrate. Subsequently it is tempered or baked at 130° C. in the oven in air for 1 h. The so obtained electrode is subsequently hot-pressed on the proton exchange membrane. As an alternative measure the ink can also directly be sprayed onto the ion exchange membrane as the substrate.

The so obtained membrane electrode assembly (MEA) is used in a DEFC cell and provides significant higher power densities than a membrane electrode assembly (MEA) with comparable metal loading where only Pt/Sn or PtRu catalysts have been used (see FIGS. 1 and 2).

### 2) Preparation of a MEA from Gas Diffusion Electrodes by Means of Doctor Blades or Brushes and Followed by Hot-Pressing

The catalyst components are mixed in the ratio 2:1 and treated with the fivefold amount of water. Subsequently a Nafion dispersion has been added, so that the Nafion proportion on the solid amounts to 40 wt.-%. Then the ink is subjected intimate mixing. About 10 minutes before the processing di-ammonium carbonate has been added to the ink as a powder. The amount of di-ammonium carbonate has been selected in a manner so that it corresponds to about 10% of the solid's content. Subsequently the ink is applied layer by layer on a gas diffusion medium as the substrate with the help of a brush or a doctor blade. After each layer the electrode is tempered or baked in the oven at 130° C. for 1 h. Thereby the solvents evaporate and the ammonium carbonate, which has been added as a pore forming agent, decomposes rapidly into ammonia, carbon dioxide and water vapor. Thus, a porous—but due to the ionomer—strongly adhesive layer has been formed. After complete preparation of the electrode it is—as described in the example 1-hot-pressed together with the electrolyte membrane.

### 3) MEA with a Layer Structure of the Electrode by Hot Spraying

The two catalyst components are weighed separately in the weight ratio 2:1 and in each case separately the tenfold amount of water and Nafion solution has been added and dispersed. Again the amount of Nafion solution is selected in a manner so that later in each case the proportion of Nafion on the solid amounts to 40 wt.-%. Subsequently, at first the ink containing component A is sprayed on an ionomer membrane being heated at 120-140° C. Afterwards the ink containing component B is sprayed onto the layer of component A, also at 120-140° C. Finally the MEA is tempered or baked in the oven for 1 h at 130° C. in air.

### 4) MEA Having a Gradient Configuration of the Components by Coating with Doctor Blades and Hot-Pressing

Step A) Five inks have been prepared which contain components A and B in the ratios 3:1, 2:1, 1:1, 1:2 and 1:3. For this purpose components A and B are weighed in each case in the corresponding weight ratio and in each case the fivefold amount of water and Nafion solution have been added. Again the amount of Nafion solution is in each case selected in an manner so that later the Nafion proportion on the solid amounts to 40 wt.-%. The ink is added approximately 10 minutes before the processing of di-ammonium carbonate, so that its portion of solid amounts to 10 wt.-%.

Step b) At the edge of a suitable substrate e.g. carbon felt of the type Sigracet 35AC a stripe of each ink is applied over a fifth of the length of the edge in the order of the ratios A:B=3:1, 2:1, 1:1, 1:2, 1:3. Thereafter the ink is uniformly distributed over the substrate away from the applying edge by means of a doctor blade. The so obtained first electrode layer is dried in the oven at 130° C. in air, so that—as described in the example 2)—a porous, strongly adhesive structure has been formed.

Step c) Step b is repeated as often as the desired metal loading has been achieved. Stripes having the same catalyst composition are always arranged one above the other.

Step d) The electrode is connected by hot-pressing with a Nafion membrane and a cathode electrode to obtain a MEA.

Step e) The finished MEA is incorporated into a DEFC or a DEFC stack, whereby the stripe with the highest concentration of component A is oriented to the fuel inlet and the stripe with the highest concentration of component B to the fuel discharge opening (see FIG. 4).

1. An electrode comprising at least two catalytically active components (A) and (B) which are not alloyed with one another and which are present on and/or within the said electrode, wherein
(a) at least one first catalytically active metal and/or alloy as component (A) oxidizes ethanol and/or at least one C3 to C10 containing alcohol and
(b) at least one second catalytically active metal and/or alloy as component (B) oxidizes acetaldehyde (CH₃CHO) and/or at least one C3 to C10 containing aldehyde and/or acetic acid and/or at least one C2 to C9 containing carboxylic acid.

2. The electrode according to claim 1, wherein
(a) the component (A) is an alloy and comprises apart from the element of the group 10 of the periodic table an element of the group 14 of the periodic table;
(b) the component (B) is an alloy and comprises apart from the element of the group 10 of the periodic table an element of the group 8 of the periodic table;

3. The electrode according to claim 1, wherein the component (A) and/or the component (B) is/are an alloy.

4. The electrode according to claim 1, wherein the component (A) and/or the component (B) is/are on a support.

5. The electrode according to claim 4, wherein the support is carbon.

6. The electrode according to claim 1, wherein the component (A) oxidizes ethanol and/or at least one C3 to C10 containing alcohol to obtain acetaldehyde (CH₃CHO) and/or to obtain at least one C3 to C10 containing aldehyde.

7. The electrode according to claim 1, wherein the first catalytically active metal and/or alloy as component (A) is or comprises an element of the group 10 of the periodic table, preferably platinum (Pt).

8. The electrode according to claim 1, wherein the component (A) is an alloy and comprises apart from the element of the group 10 of the periodic table, preferably platinum (Pt), an element of the group 14 of the periodic table, preferably tin (Sn).

9. The electrode according to claim 2, wherein the element of the group 10 of the periodic table is platinum (Pt) and the element of the group 14 of the periodic table is tin (Sn).

10. The electrode according to claim 1, wherein the component (B) oxidizes acetaldehyde (CH₃CHO) and/or at least one C3 to C10 containing aldehyde to obtain CO₂.

11. The electrode according to claim 1, wherein the second catalytically active metal and/or alloy as component (B) is or comprises an element of the group 10 of the periodic table, preferably platinum (Pt).

12. The electrode according to claim 1, wherein the component (B) is an alloy and comprises apart from the element of the group 10 of the periodic table, preferably platinum (Pt), an element of the group 8 of the periodic table, preferably ruthenium (Ru).

13. The electrode according to claim 2, wherein the element of the group 10 of the periodic table is platinum (Pt) and the element of the group 8 of the periodic table is ruthenium (Ru).

14. The electrode according to claim 1, wherein the weight ratio of the metal portion between component (A) and component (B) amounts to 3:1 to 1:3.

15. The electrode according to claim 1, wherein the electrode comprises an ionomer.

16. The electrode according to claim 1, wherein the electrode contains 30 to 50 weight percents of an ionomer.

17. The electrode according to claim 1, wherein the electrode comprises a pore forming agent.

18. A use of the electrode according to claim 1, as an anode.

19. The use according to claim 18, wherein the electrode is used in a membrane electrode assembly (MEA).

20. The use according to claim 18, wherein the electrode is used in a fuel cell.

21. A membrane electrode assembly, wherein the membrane electrode assembly comprises an anode, a proton exchange membrane and a cathode, wherein the anode is an electrode having at least two catalytically active components (A) and (B) which are not alloyed with one another and which are present on and/or within the said electrode, wherein
(a) at least one first catalytically active metal and/or alloy as component (A) oxidizes ethanol and/or at least one C3 to C10 containing alcohol and
(b) at least one second catalytically active metal and/or alloy as component (B) oxidizes acetaldehyde (CH₃CHO) and/or at least one C3 to C10 containing aldehyde and/or acetic acid and/or at least one C2 to C9 containing carboxylic acid.

22. The assembly according to claim 21, wherein the proton exchange membrane comprises an ionomer.

23. A fuel cell comprising, an electrode or a membrane electrode assembly, wherein the electrode has at least two catalytically active components (A) and (B) which are not alloyed with one another and which are present on and/or within the said electrode, wherein
(a) at least one first catalytically active metal and/or alloy as component (A) oxidizes ethanol and/or at least one C3 to C10 containing alcohol and
(b) at least one second catalytically active metal and/or alloy as component (B) oxidizes acetaldehyde (CH₃CHO) and/or at least one C3 to C10 containing aldehyde and/or acetic acid and/or at least one C2 to C9 containing carboxylic acid; and
wherein the membrane electrode assembly has an anode, a proton exchange membrane and a cathode, wherein the anode is the electrode.

24. The fuel cell according to claim 23, wherein the fuel cell is a direct ethanol fuel cell.

25. A preparation comprising, an electrode having at least two catalytically active components (A) and (B) which are not alloyed with one another and which are present on and/or within the said electrode, wherein
(a) at least one first catalytically active metal and/or alloy as component (A) oxidizes ethanol and/or at least one C3 to C10 containing alcohol and
(b) at least one second catalytically active metal and/or alloy as component (B) oxidizes acetaldehyde (CH₃CHO) and/or at least one C3 to C10 containing aldehyde and/or acetic acid and/or at least one C2 to C9 containing carboxylic acid,
wherein the first catalytically active metal and/or alloy (A) and the second catalytically active metal and/or alloy (B) are mixed.

26. The preparation according to claim 25, wherein
(a) the first catalytically active metal and/or alloy (A) and the second catalytically active metal and/or alloy (B) are mixed;
(b) water and an ionomer dispersion are added to the mixture and are blended; and
(c) sprayed onto a substrate.

27. The preparation according to claim 25, wherein
(a) the first catalytically active metal and/or alloy (A) and the second catalytically active metal and/or alloy (B) are mixed in several mixtures having different ratios;
(b) water and an ionomer dispersion are added to the individual mixtures and are blended;
(c) the individual mixtures are coated with a doctor knife onto a substrate in the form of stripes, so that the sequence of the stripes forms a linear gradient in the ratio of component A to component B.

28. The preparation according to claim 25, wherein the first catalytically active metal and/or alloy (A) and the second catalytically active metal and/or alloy (B) are arranged in layers.

29. A preparation of a membrane electrode assembly, comprising, preparing an anode, wherein the anode is an electrode having at least two catalytically active components (A) and (B) which are not alloyed with one another and which are present on and/or within the said electrode, wherein
(a) at least one first catalytically active metal and/or alloy as component (A) oxidizes ethanol and/or at least one C3 to C10 containing alcohol and
(b) at least one second catalytically active metal and/or alloy as component (B) oxidizes acetaldehyde (CH₃CHO) and/or at least one C3 to C10 containing aldehyde and/or acetic acid and/or at least one C2 to C9 containing carboxylic acid;
wherein the first catalytically active metal and/or alloy (A) and the second catalytically active metal and/or alloy (B) are mixed; and
the anode is applied onto the proton exchange membrane by hot-pressing.
